(19) United States
(12) Patent Application Publication
(10) Pub. No.: US 2025/0183459 A1
(43) Pub. Date: Jun. 5, 2025

(54) METHOD FOR ASSEMBLING AN ELECTRIC BATTERY

(71) Applicant: G.D. S.P.A., Bologna (IT)

(72) Inventors: Giacomo Noferini, Bologna (IT); Massimo Fortini, Bologna (IT)

(21) Appl. No.: 18/840,663

(22) PCT Filed: Dec. 19, 2022
(86) PCT No.: PCT/IB2022/062468

§ 371 Date: Aug. 22, 2024

(30) Foreign Application Priority Data
Feb. 25, 2022 (IT) 102022000003533
Feb. 25, 2022 (IT) 102022000003536
May 23, 2022 (IT) 102022000010661

(51) Int. Cl. H01M 50/271; H01M 10/04

(52) U.S. Cl. CPC H01M 50/271; H01M 10/0404

(57) ABSTRACT

A method for assembling an electric battery comprises providing a hollow container having a side wall and a bottom wall defining an inner cavity; providing an upper portion of the hollow container comprising an outer surface; providing an insert made of electrically conductive material comprising a connection portion; providing a lid; inserting an electrochemical cell into the inner cavity of the hollow container; connecting the insert to a pole of the electrochemical cell; closing the inner cavity of the hollow container with the lid, creating an overlapping region in which the upper portion of the hollow container is positioned axially above the lid and the connection portion. Welding together at least the connection portion of the insert and the upper portion of the hollow container at the overlapping region by acting with a welder on the side facing the outer surface of the upper portion of the hollow container.

### CROSS-REFERENCE TO RELATED APPLICATION DATA

This application is a U.S. National Stage Application of International Application No. PCT/IB2022/062468, filed Dec. 19, 2022, which claims the benefit of and priority to Italian Patent Application No. 102022000003533, filed Feb. 25, 2022, Italian Patent Application No. 102022000003536, filed Feb. 25, 2022 and Italian Patent Application No. 102022000010661, filed May 23, 2022 the disclosure of each is incorporated herein by reference in its entirety.

### TECHNICAL FIELD

The present invention refers to a method for assembling an electric battery of the type usable in applications in which it is necessary to make electrical energy available.

### BACKGROUND

Electric batteries, also called secondary electrochemical cells or rechargeable batteries, are devices that convert chemical energy into electrical energy with a reversible oxidation-reduction reaction and that convert electrical energy into chemical energy by reversing this oxidation-reduction process.

The electric batteries comprise a hollow container inside which cavity an electrochemical cell formed by an anode, a cathode and a separator placed between anode and cathode is inserted. The cathode is electrically connected to a base bottom of the container and the anode is electrically connected to a top plate of the container.

In some types of applications, the electrochemical cell inserted into the hollow container is an electrochemical cell of the type called jelly roll or Swiss roll which comprises a sheet of insulating material on which an anode material, a separator material and a cathode material are laid, in succession and in the form of a lamina or sheet. The multilayer thus composed is wound on itself and placed into the cavity of the container. The cathode material is put in electrical contact with an electrical pole placed on the bottom of the hollow container and electrically isolated from the container itself. The anode material is put in electrical contact with a lid which is placed to close the container and which creates a further electrical pole.

Examples of such applications are lithium-ion rechargeable batteries, nickel-cadmium rechargeable batteries and nickel-metal hydride rechargeable batteries.

In the Applicant's experience, for assembling electrical batteries of the type briefly described above, an insert made of electrically conductive material, for example in copper, is first welded to the anode material of the electrochemical cell. The electrochemical cell is then inserted into the cavity of the hollow container. At this point, since the side wall of the hollow container must be electrically connected with the anode material, the insert made of electrically conductive material placed inside the hollow container is welded to the inner surface of the side wall of the hollow container. Once welded, the hollow container is closed with a lid put in electrical contact with the side wall of the hollow container, so that the lid assumes the same electrical potential as the side wall of the hollow container.

The Applicant has noted that in the method for assembling electrical batteries briefly described above it could be difficult, or in any case expensive in terms of large-scale production efficiency, to weld the insert made of electrically conductive material inside the cavity of the hollow container and to the inner surface of the side wall of the hollow container.

The Applicant has in fact verified that there may be a very limited space available for welding between the insert made of electrically conductive material and the inner surface of the side wall of the hollow container, since this welding is carried out when the electrochemical cell is already inserted into the hollow container.

The Applicant also noted that if welding residues during the welding operation between the insert made of electrically conductive material and the inner surface of the side wall of the hollow container reached the electrochemical cell, the correct operation of the electric battery could be compromised.

The Applicant has perceived that the method for assembling electrical batteries described above briefly could be improved.

The Applicant has in fact perceived that after positioning the electrochemical cell inside the hollow container it is necessary to close the hollow container, at a free rim, with the lid.

The Applicant has perceived that the insert made of electrically conductive material could be extended and reach the union zone between the free rim of the hollow container and the lid in such a way as to create an axial overlapping region between the insert made of electrically conductive material, the free rim of the hollow container and the lid in which the free rim of the hollow container is axially the outermost.

The Applicant has therefore found that by applying heat at this overlapping region with the lid already placed to cover the hollow container, it would be possible to join together at least portions of the free rim of the hollow container and of the insert made of electrically conductive material ensuring an electrical continuity between the insert made of electrically conductive material and the hollow container. The Applicant has also found that by applying this heat using a welder that operates, at the overlapping region, on the side facing the outer surface of the free rim of the hollow container, the welding (or weldings) that guarantees the electrical contact between the insert made of electrically conductive material and the hollow container would be made on an outer surface of the electric battery substantially already assembled, preventing the risk that any welding residues reach the electrochemical cell and avoiding having to weld in very narrow spaces.

The present invention therefore concerns a method for assembling an electric battery.

### SUMMARY

Preferably, it is envisaged providing a hollow container having a side wall and a bottom wall defining an inner cavity.

Preferably, it is envisaged providing an upper portion of the hollow container opposite to said bottom wall along an axial direction and comprising an outer surface.

Preferably, it is envisaged providing an insert made of electrically conductive material comprising a connection portion.

Preferably, it is envisaged providing a lid.

Preferably, it is envisaged inserting an electrochemical cell into the inner cavity of said hollow container.

Preferably, it is envisaged mechanically and electrically connecting the insert made of electrically conductive material to a pole of said electrochemical cell.

Preferably, it is envisaged closing the inner cavity of the hollow container with the lid, creating an overlapping region in which the upper portion of the hollow container is positioned axially above the lid and the connection portion of the insert made of electrically conductive material.

Preferably, it is envisaged welding together at least the connection portion of the insert made of electrically conductive material and the upper portion of the hollow container at the overlapping region by acting with a welder on the side facing the outer surface of the upper portion of the hollow container.

The Applicant has verified that the welding between at least the connection portion of the insert made of electrically conductive material and the upper portion of the hollow container actually places the hollow container with the insert made of electrically conductive material (which in turn is in electrical contact with a pole of the electrochemical cell) in permanent electrical contact.

The Applicant has also verified that by acting with a welder on the side facing the outer surface of the upper portion of the hollow container, a welding can be made that melts, directly or through the upper portion of the hollow container, a region of the contact portion of the insert made of conductive material by melting it at least with the upper portion of the hollow container.

The Applicant considers that this allows to avoid having to weld the insert made of electrically conductive material inside the cavity of the hollow container on the internal surface of the hollow container.

The terms “axial and radial” are used referring respectively to a parallel direction and to a direction contained in a plane perpendicular to a main development axis of the electric battery.

The terms “radially innermost” and “radially outermost” indicate a position respectively closer to, and further from, the axis of rotation of the tyre.

The terms “axially outermost” or “axially above” indicate a position furthest from a plane perpendicular to the main development axis of the electric battery and passing through the centre of gravity of the electric battery.

The terms “axially innermost” or “axially below” indicate a position closest to a plane perpendicular to the main development axis of the electric battery and passing through the centre of gravity of the electric battery.

The term “electrically conductive material” means in the present description and in the subsequent claims a material capable of having electrical current flow within it and having an electrical conductivity greater than 1×10⁴ siemens/metre at 20° C., preferably greater than 1×10⁵ siemens/metre at 20° C., more preferably greater than 1×10⁶ siemens/metre at 20° C.

The term “mechanically joining” or “mechanical union” in the present description and in the subsequent claims means joining together two or more parts or components so as to form an assembly in which the parts or components of the assembly are mechanically constrained together.

By the term “direct physical contact” it is meant in the present description and in the subsequent claims a physical contact between two parts or components with no means interposed between the two parts or components.

The term “direct electrical contact” in the present description and in the subsequent claims means an electrical continuity between two parts or components without electrical conductive means interposed between the two parts or components.

The term “electrical contact” in the present description and in the subsequent claims means an electrical continuity between two parts or components. An electrical contact between two parts or components may be direct or may have electrical conductive means interposed between the two parts or components.

The term “plastic deformation” or “plastically deformed” means in the present description and in the subsequent claims a deformation that does not disappear when the force that caused such deformation ceases.

The term “cold plastic deformation” means in the present description and in the subsequent claims a processing of metals that takes place at a processing temperature that is less than 40% of the melting temperature of the metal being processed, preferably less than 30% of the melting temperature of the metal being processed. For example, in a metal material having a melting temperature of 1000° C., a cold deformation occurs at a processing temperature of less than 400° C., preferably less than 300° C.

The present invention may exhibit at least one of the preferred features described below. Such features may be present individually or in combination with each other, unless expressly stated otherwise, in the method for assembling an electric battery of the present invention.

Preferably, it is not envisaged welding the insert made of electrically conductive material and an inner wall of the hollow container at axial positions between the bottom wall of the hollow container and the peripheral portion of the lid.

Preferably, welding together at least the connection portion of the insert made of electrically conductive material and the upper portion of the hollow container further comprises welding together the insert made of electrically conductive material and the lid.

Preferably, the connection portion of the insert made of electrically conductive material, the upper portion of the hollow container and the lid are welded together simultaneously.

Preferably, in said overlapping region the connection portion of the insert made of electrically conductive material is axially interposed between, and in contact with, the upper portion of the hollow container and the lid.

Preferably, creating said overlapping region comprises arranging said upper portion of the hollow container in such a way that it does not axially overlap a free end of said connection portion of the insert made of electrically conductive material.

Preferably, creating said overlapping region comprises not axially overlapping a radially inner free end of said connection portion of the insert made of electrically conductive material with the upper portion of the hollow container.

Preferably, welding comprises performing a welding by crossing the outer surface of the upper portion of the hollow container until reaching at least the connection portion of the insert made of electrically conductive material.

Preferably, welding comprises performing a welding by crossing the outer surface of the upper portion of the hollow container, crossing the connection portion of the insert made of electrically conductive material until reaching the lid.

Preferably, welding comprises directing a beam emitted by a laser welder onto the outer surface of the upper portion of the hollow container.

Preferably, a size of a spot of the laser welder is between 30 microns and 300 microns, more preferably between 30 microns and 200 microns, more preferably between 30 microns and 100 microns, for example about 60 microns.

Preferably, said laser welder emits a laser beam on said outer surface of the upper portion of the hollow container having a fluence (energy per unit area) between 50 Joule/square centimetre and 5000 Joule/square centimetre, more preferably between 50 Joule/square centimetre and 5000 Joule/square centimetre, more preferably between 100 Joule/square centimetre and 2000 Joule/square centimetre, more preferably between 200 Joule/square centimetre and 1000 Joule/square centimetre, for example between 400 Joule/square centimetre and 700 Joule/square centimetre.

Preferably, a power of said laser welder is between 500 Watt and 3000 Watt, more preferably between 800 Watt and 2500 Watt, more preferably between 1000 Watt and 2000 Watt, more preferably between 1200 Watt and 1800 Watt, for example of about 1500 Watt.

Preferably, a feed rate of the laser beam along the outer surface of the upper portion of the hollow container during welding is between 100 millimetres per second and 2000 millimetres per second, more preferably between 150 millimetres per second and 1500 millimetres per second, more preferably between 200 millimetres per second and 800 millimetres per second, more preferably between 250 millimetres per second and 650 millimetres per second, for example of about 450 millimetres per second.

Preferably directing a beam emitted by a laser welder onto the outer surface of the upper portion of the hollow container comprises performing an annular welding.

Preferably, performing an annular welding is obtained by directing the beam emitted by the laser welder along an annular path on the outer surface of the upper portion of the hollow container.

Preferably, directing a beam emitted by a laser welder onto the outer surface of the upper portion of the hollow container comprises rotating said laser beam such that the laser beam travels a circular path on the outer surface of the upper portion of the hollow container.

Alternatively, directing a beam emitted by a laser welder onto the outer surface of the upper portion of the hollow container preferably comprises rotating said battery under said laser beam such that the laser beam travels a circular path on the outer surface of the upper portion of the hollow container.

Alternatively, directing a beam emitted by a laser welder onto the outer surface of the upper portion of the hollow container preferably comprises performing a spot welding.

Preferably, performing a spot welding is obtained by directing the beam emitted by the laser welder onto spots of the outer surface of the upper portion of the hollow container.

Preferably, in this case directing a beam emitted by a laser welder onto the outer surface of the upper portion of the hollow container comprises rotating said laser beam such that the laser beam travels a circular path on the outer surface of the upper portion of the hollow container and interrupting the emission of the laser beam at predetermined time intervals.

Alternatively, directing a beam emitted by a laser welder onto the outer surface of the upper portion of the hollow container preferably comprises rotating said battery under said laser beam such that the laser beam travels a circular path on the outer surface of the upper portion of the hollow container and interrupting the emission of the laser beam at predetermined time intervals.

Alternatively, preferably welding comprises melting said free end of the connection portion of the insert made of electrically conductive material.

Preferably, melting said free end of the connection portion of the insert made of electrically conductive material comprises melting said free end until it radially reaches the upper portion of the hollow container and said lid.

Preferably, welding together at least the connection portion of the insert made of electrically conductive material and the upper portion of the hollow container is preceded by closing the inner cavity of the hollow container with the lid.

Preferably, closing the inner cavity of the hollow container comprises mechanically joining the connection portion of the insert made of electrically conductive material, the upper portion of the hollow container and a peripheral portion of the lid.

Preferably, mechanically joining the connection portion of the insert made of electrically conductive material, the upper portion of the hollow container and a peripheral portion of the lid comprises plastically deforming at least the connection portion of the insert made of electrically conductive material and the upper portion of the hollow container.

Preferably, mechanically and electrically connecting the insert made of electrically conductive material to a pole of said electrochemical cell is performed prior to inserting the electrochemical cell into the inner cavity of said hollow container.

Preferably, mechanically joining the connection portion of the insert made of electrically conductive material, the upper portion of the hollow container and a peripheral portion of the lid is preceded by placing the connection portion of the insert made of electrically conductive material in electrical contact with the upper portion of the hollow container.

Preferably, mechanically joining the connection portion of the insert made of electrically conductive material, the upper portion of the hollow container and a peripheral portion of the lid is preceded by placing the peripheral portion of the lid in contact with the connection portion of the insert made of electrically conductive material.

Preferably, placing the connection portion of the insert made of electrically conductive material in electrical contact with the upper portion of the hollow container comprises at least partially overlapping the connection portion of the insert made of electrically conductive material with the upper portion of the hollow container.

Preferably, placing the peripheral portion of the lid in contact with the connection portion of the insert made of electrically conductive material comprises putting in physical contact the peripheral portion of the lid with the connection portion of the insert made of electrically conductive material.

Preferably, placing the peripheral portion of the lid in contact with the connection portion of the insert made of electrically conductive material comprises at least partially overlapping the peripheral portion of the lid with the connection portion of the insert made of electrically conductive material.

Preferably, placing the connection portion of the insert made of electrically conductive material in electrical contact with the upper portion of the hollow container precedes placing the peripheral portion of the lid in contact with the connection portion of the insert made of electrically conductive material.

Preferably, placing the connection portion of the insert made of electrically conductive material in electrical contact with the upper portion of the hollow container is subsequent to inserting an electrochemical cell into the inner cavity of said hollow container.

Preferably, mechanically joining the connection portion of the insert made of electrically conductive material, the upper portion of the hollow container, and the peripheral portion of the lid is subsequent to placing the peripheral portion of the lid in contact with the connection portion of the insert made of electrically conductive material.

Preferably, mechanically joining the connection portion of the insert made of electrically conductive material, the upper portion of the hollow container and the peripheral portion of the lid and putting the peripheral portion of the lid in electrical contact with the upper portion of the hollow container are implemented simultaneously.

Preferably, mechanically and electrically connecting the insert made of electrically conductive material to a pole of said electrochemical cell comprises mechanically and electrically connecting the insert made of electrically conductive material to an anode of said electrochemical cell.

Preferably, mechanically and electrically connecting the insert made of electrically conductive material to the anode of said electrochemical cell comprises welding said anode to said insert made of electrically conductive material.

Preferably, welding said anode to said insert made of electrically conductive material comprises welding a contact portion of the insert made of electrically conductive material to the anode of said electrochemical cell.

Further characteristics and advantages of the present invention will become clearer from the following detailed description of a preferred embodiment thereof, with reference to the appended drawings and provided by way of indicative and non-limiting example, in which:

### BRIEF DESCRIPTION OF THE DRAWINGS

FIG. 1 is a schematic sectional view of an electric battery assembled in accordance with the method of the present invention;

FIG. 2 is an enlarged schematic view of a detail of the electrical battery of FIG. 1 according to a first embodiment;

FIG. 3 is an enlarged schematic view of a detail of the electrical battery of FIG. 1 according to a second embodiment;

FIGS. 4 and 5 are details in a top view of the detail of FIGS. 3 and 4, respectively;

FIGS. 6 and 7 are details in a top view of the same detail of FIGS. 3 and 4 in further embodiments;

FIG. 8 is an enlarged schematic view of a detail of the electric battery of FIG. 1 according to a third embodiment;

FIG. 9 shows a detail in a top view of FIG. 8;

FIGS. 10 and 11 are schematic views respectively from the side and from the top of a component of the electric battery of FIG. 1;

FIG. 12 is a perspective schematic view of a further component of the electric battery of FIG. 1;

FIGS. 13 to 14 are schematic representations of some battery assembly sequences of FIG. 1; and

FIG. 15 is an enlarged schematic view of a detail of the electric battery of FIG. 1 according to a further embodiment.

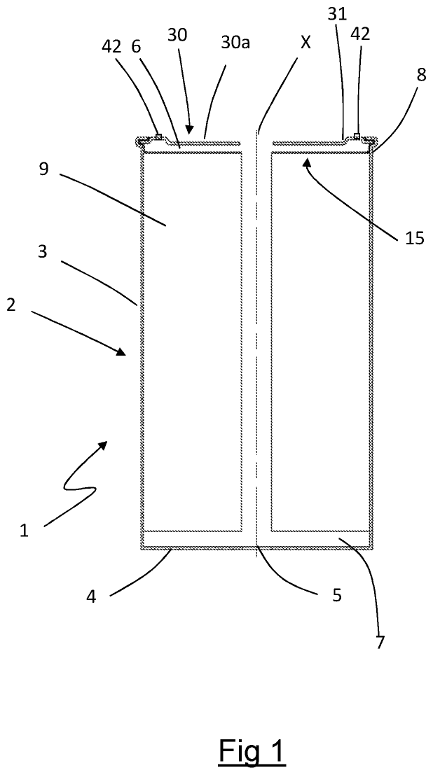

### DETAILED DESCRIPTION

The representations in the accompanying figures do not necessarily have to be understood in scale and do not necessarily respect the proportions between the various parts. In the figures, the same or similar elements of different embodiments will be indicated by the same reference numerals.

An electric battery made in accordance with the assembly method of the present invention is indicated generically by the numerical reference 1.

A main development axis X is defined in the battery 1. An axial direction parallel to the main development axis X, a radial direction contained in a plane perpendicular to the main development axis X and passing through the main development axis X and a circumferential direction arranged around the main development axis X and contained in a plane perpendicular to the main development axis X are also defined.

For ease of exposure, explicit reference will be made to an electric battery 1 of a generally cylindrical shape in which the main development axis X substantially coincides with an axis of symmetry of the electric battery 1.

However, the electric battery 1 may have different shapes from the cylindrical one, for example it may have a straight prism shape, for example with a rectangular base.

The electric battery 1 comprises a hollow container 2, a lid 30, an electrochemical cell 9 and an insert made of electrically conductive material 15.

The hollow container 2 comprises a side wall 3 and a bottom wall 4. The side wall 3 and the bottom wall 4 are made as one piece of steel. The bottom wall 4 and the side wall 3 define an inner cavity 7 of the hollow container 2. The bottom wall 4 and the side wall 3 preferably have the same thickness. The thickness of the side wall 3 and the bottom wall 4 is preferably between 0.2 millimetres and 0.6 millimetres, for example of 0.3 millimetres.

An electrical pole 5 is placed on the bottom wall 4 of the hollow container 2 and is electrically insulated from the bottom wall 4. The electrical pole 5 is placed in a central position on the bottom wall 4.

In an unassembled condition of the electric battery 1, the hollow container 2 has an opening 6 on the opposite side with respect to the bottom wall 4. The hollow container 2 comprises an upper portion 8 opposite to the bottom wall 4 along an axial direction. The upper portion 8 develops circumferentially around the opening 6.

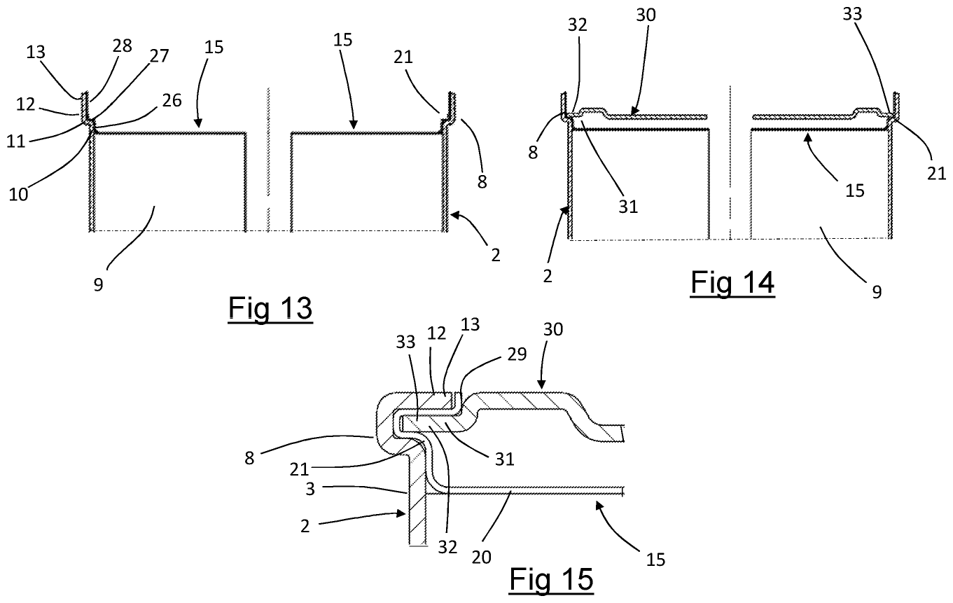

The upper portion 8 comprises, in an unassembled condition of the electric battery 1, a straight section 10 (in an axial direction) that create an annular extension of the side wall 3 of the hollow container 2 (FIG. 13). This straight section 10 is made as one piece with the side wall 3 of the hollow container 2. A curved section 11 that projects radially outward and that develops circumferentially forming a radially enlarged section for the upper portion 8 is connected to the straight section 10. From the curved section 11 a further straight section 12 develops (in an axial direction) which develops circumferentially to form a further annular section. The upper portion 8 ends with a free end 13. This free end 13 is also the free end of the further straight section 12.

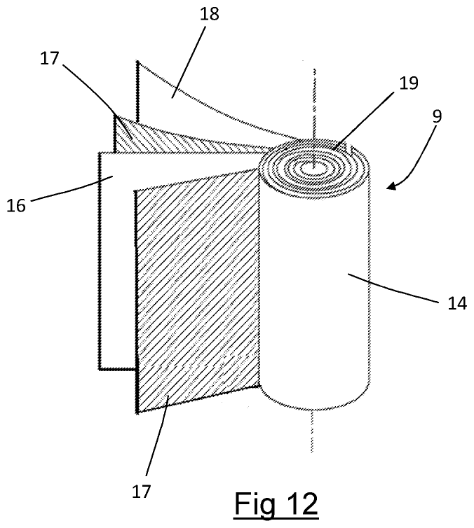

The electrochemical cell 9, better illustrated in FIG. 12, comprises an anode and a cathode.

The electrochemical cell 9 is of the jelly-roll or Swiss-roll type and comprises a multilayer 14 wound on itself. The multilayer 14 comprises a first layer 16 made of an anode material, which creates the anode of the electrochemical cell 9, and a second layer 17 made up of a cathode material, which creates the cathode of the electrochemical cell 9. The multilayer 10 further comprises a third separator layer (or more third layers) 18 separating the first layer 16 from the second layer 17. A person skilled in the art will be able to choose the material of the first layer 16, the second layer 17 and the third layer 18 to give the electrochemical cell 9 the desired electrical performance.

In preferred embodiments, the first layer 16 is axially offset from the second layer 17 so as to emerge axially from the multilayer 14 wound on itself with respect to the second layer 17. The portion of the first layer 16 that emerges axially from the multilayer 14 is plastically deformed in such a way that the free rim of the first layer 16 is bent to form an anode surface 19. This anode surface 19 is irregular and not continuous and has the function of increasing the contact surface of the first layer 16 at the axial end of the electrochemical cell 9.

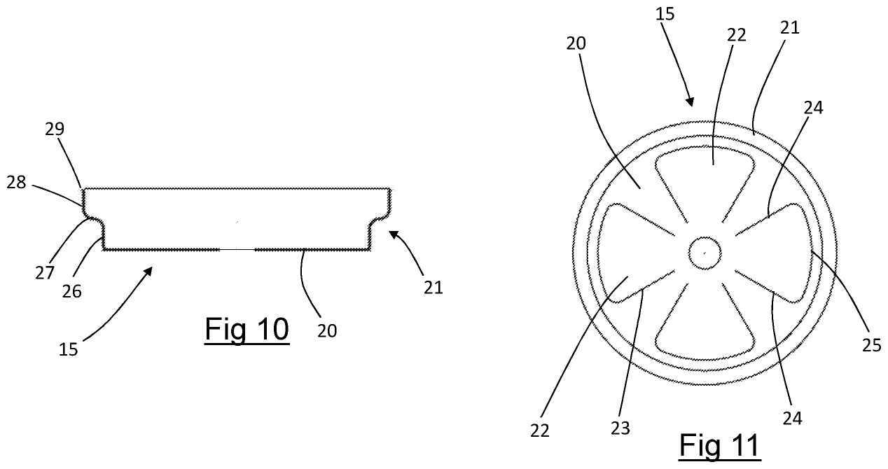

The insert made of electrically conductive material 15 is preferably made of copper. As best illustrated in FIGS. 10 and 11 (wherein the insert made of electrically conductive material 15 is illustrated not yet assembled in the electric battery 1), the insert made of electrically conductive material 15 has a shape along a section perpendicular to an axial direction which is substantially coincident with the shape of the bottom wall 4 of the hollow container 2. In the illustrated embodiment, the shape of the insert made of electrically conductive material 15 along a section perpendicular to an axial direction is substantially circular.

The insert made of electrically conductive material 15 comprises a substantially flat contact portion 20. The insert made of electrically conductive material 15 further comprises a connection portion 21. The connection portion 21 emerges axially from the radial end of the contact portion 20 and develops axially away from the contact portion 20.

A plurality of fins 22 are provided on the contact portion 20. Each fin 22 is defined by a respective through notch 23 that passes through the contact portion 20 in an axial direction. Each through notch 23 follows a curved trajectory comprising two side sections 24 and a central section 25 (FIG. 11). The side portions 24 develop along respective radial directions from a central region of the contact portion 20 until they reach a peripheral region of the contact portion 20. The central section 25 connects the two side sections 24 and has a substantially circumferential development. As schematically illustrated in FIG. 11, each fin 22 is substantially petal-shaped and can be raised in an axial direction by rotating around a virtual hinge axis that joins the free ends of the two side sections 24 of the notches 23. The fins 22 are preferably between 2 and 8 in number, for example the fins 18 are 4.

FIG. 10 shows a side view of the insert made of electrically conductive material 15 (in an unassembled condition). The connection portion 17 comprises a straight section 26 (in an axial direction) that develops circumferentially to form an annular section. The straight section 26 is directly connected to the contact portion 20. A curved section 27 that projects radially outward and that develops circumferentially forming a radially enlarged section for the upper portion 17 is connected to the straight section 26. From the curved section 27 a further straight section 28 develops (in an axial direction) which develops circumferentially to form a further annular section. The connection portion 17 ends with a free end 29. This free end 29 is also the free end of the further straight section 28.

The lid 30 is made of steel. The lid 30 has a shape along a section perpendicular to an axial direction which is substantially coincident with the shape of the bottom wall 4 of the hollow container 2. In the illustrated embodiment, the shape of the lid 30 along a section perpendicular to an axial direction is substantially circular.

The lid may comprise one or more stiffening ribs. The lid 30 comprises a peripheral portion 31 radially surrounding a central portion 30a.

The peripheral portion 31 comprises, in an unassembled condition of the electric battery 1, a straight section 32 (FIG. 14) that develops in the radial direction. The peripheral portion 31 ends with a free end 33. This free end 33 is also the free end of the straight section 32.

In the assembled condition of the electric battery 1, the electrochemical cell 9 is inserted into the inner cavity 7 of the hollow container 2 with the cathode facing the bottom wall 4. The cathode is electrically connected with the electrical pole 5. In particular, the second layer 17 of the multilayer 14 is placed in electrical connection with the electrical pole 5 placed on the bottom wall 4 of the hollow container 2.

The anode is electrically connected with the insert made of electrically conductive material 15. This electrical connection is implemented by welding the contact portion 20 on the anode. In particular, the anode surface 19 is welded to the fins 22 of the contact portion 20 of the insert made of electrically conductive material 15.

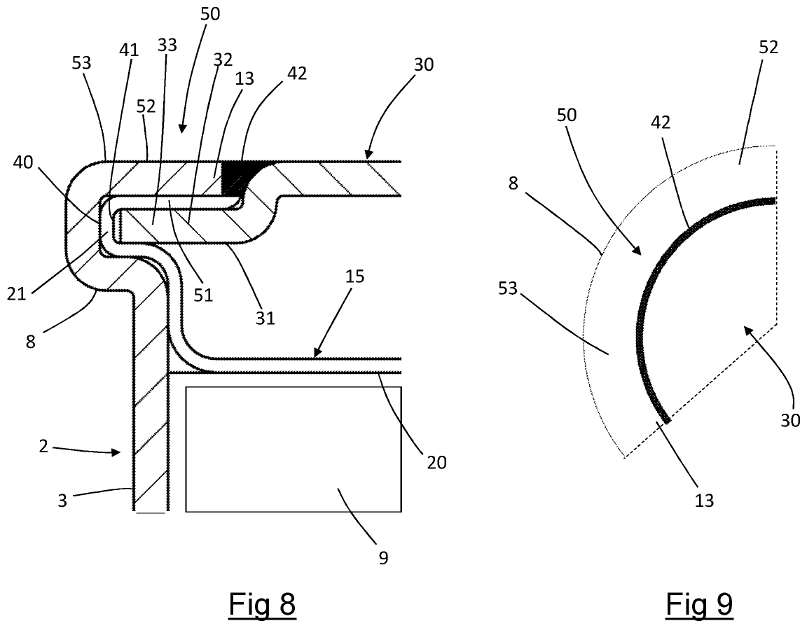

In the assembled condition of the electric battery 1 the connection portion 21 of the insert made of electrically conductive material 15 is interposed between the upper portion 8 of the hollow container 2 and the peripheral portion 31 of the lid 30, as schematically illustrated in FIG. 8.

The connection portion 21 of the insert made of electrically conductive material 15 is in electrical contact with the upper portion 8 of the hollow container 2 and the peripheral portion 31 of the lid 30 is in direct electrical contact with the upper portion 8 of the hollow container 2.

The connection portion 21 of the insert made of electrically conductive material 15 is in direct physical contact with the upper portion 8 of the hollow container 2.

The connection portion 21 of the insert made of electrically conductive material 15 is further in direct physical contact with the peripheral portion 31 of the lid 30.

The connection portion 21 of the insert made of electrically conductive material 15 and the upper portion 8 of the hollow container 2 are plastically deformed so as to create a stable mechanical connection between the side wall 3 of the hollow container 2, the lid 30 and the insert made of electrically conductive material 15.

The connection portion 31 of the insert made of electrically conductive material 15 is also in direct electrical contact and in direct physical contact with the peripheral portion 31 of the lid 30.

The upper portion 8 of the hollow container 2 is plastically deformed and forms a curve 40 defined between the curved section 11 and the further straight section 12.

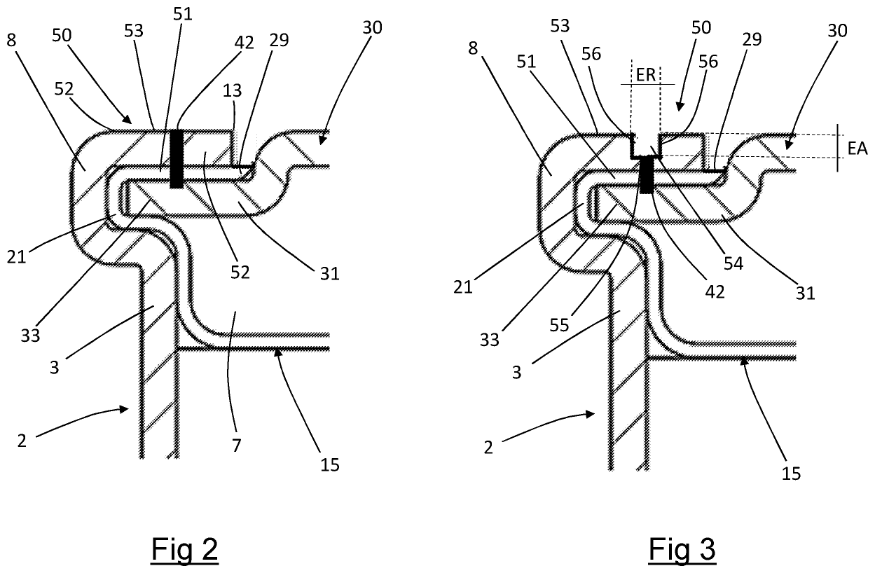

The connection portion 21 of the insert made of electrically conductive material 15 is placed radially inside the upper portion 8 of the hollow container 2. The connection portion 21 of the insert made of electrically conductive material 15 is partially contained in the curve 40, as illustrated in FIGS. 2, 3 and 8.

In this regard, the connection portion 21 of the insert made of electrically conductive material 15 is plastically deformed and forms a curve 41 defined between the curved section 27 and the further straight section 28.

The curve 41 of the connection portion 21 of the insert made of electrically conductive material 15 is inserted into the curve 40 of the upper portion 8 of the hollow container 2 and receives therein the peripheral portion 31 of the lid 30. Said peripheral portion 31 of the lid 30 is not plastically bent or deformed.

In the assembled condition of the battery, as illustrated in FIGS. 2, 3 and 8, there is provided an overlapping region 50 in which the upper portion 8 of the hollow container is positioned axially above the lid 30 and above the connection portion 21 of the insert made of electrically conductive material 15.

In such an overlapping region 50, the connection portion 21 of the insert made of electrically conductive material 15 is axially interposed between the upper portion 8 of the hollow container and the lid 30.

In particular, in the overlapping region 50, an end section 51 of the connection portion 21 of the insert made of electrically conductive material 15 is axially interposed between an end section 52 of the upper portion 8 of the hollow container 2 and the peripheral portion 31 of the lid 30.

The end section 51 of the connection portion 21 of the insert made of electrically conductive material 15 coincides with the further straight section 28 of the connection portion 21 of the insert made of electrically conductive material 15.

The end section 52 of the upper portion 8 of the hollow container 2 coincides with the further straight section 12 of the upper portion 8 of the hollow container 2.

The upper portion 8 of the hollow container 2 does not axially overlap with the free end 29 of the connection portion 21 of the insert made of electrically conductive material 15.

As illustrated in FIGS. 2, 3 and 8, the free end 13 of the upper portion 8 of the hollow container 2 is substantially facing and spaced radially from the lid 30. The free end 29 of the connection portion 21 of the insert made of electrically conductive material 15 is arranged axially between a radial space between the free end 13 of the upper portion 8 of the hollow container 2 and the lid 30.

In the overlapping region 50, the end section 51 of the connection portion 21 of the insert made of electrically conductive material 15, the end section 52 of the upper portion 8 of the hollow container 2 and the peripheral portion 31 of the lid 30 are parallel to each other and arranged along respective radial planes.

In the overlapping region 50, the upper portion 8 of the hollow container 2 has an outer surface 53 facing towards the external environment. This outer surface 53 is the axially outermost surface of the upper portion 8 of the hollow container 2.

In all embodiments of the invention, there is provided a welding 42 between at least the connection portion 21 of the insert made of electrically conductive material 15 and the upper portion 8 of the hollow container 2 placed in said overlapping region 50 on the side facing the outer surface 53 of the upper portion 8 of the hollow container 2.

The welding 42 preferably connects the connection portion 21 of the insert made of electrically conductive material 15, the upper portion 8 of the hollow container 2 and the peripheral portion 31 of the lid 30.

In accordance with the embodiment illustrated in FIGS. 2, 3, 4 and 5, the welding 42 is an annular welding which, starting from the outer surface 53 of the upper portion 8 of the hollow container 2, reaches the peripheral portion 31 of the lid 30 crossing the connection portion 21 of the insert made of electrically conductive material 15.

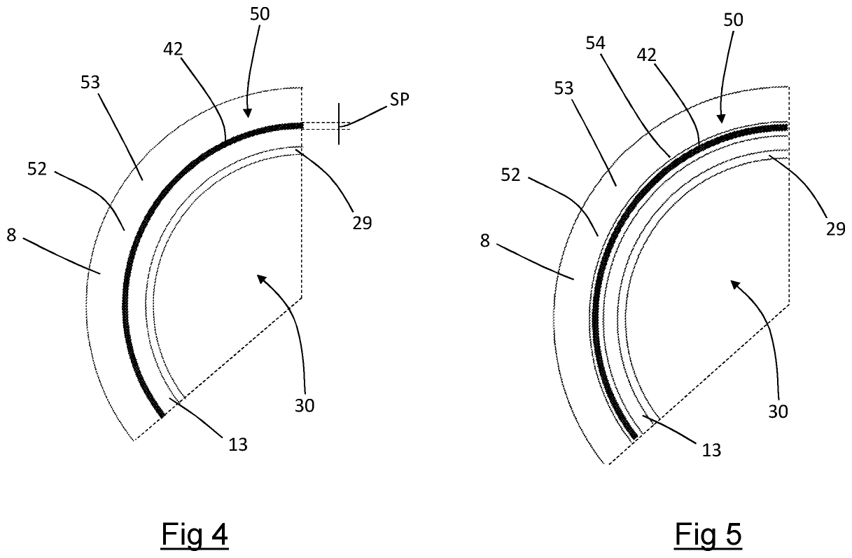

The annular welding 42 is a welding that develops with continuity along a substantially circular path on the outer surface 53 of the upper portion 8 of the hollow container 2, as schematically illustrated in FIGS. 4 and 5 (which represent top views of a portion of the battery 1).

In this embodiment, the free end 29 of the connection portion 21 of the insert made of electrically conductive material 15 is directly facing the external environment. At the free end 29 of the connection portion 21 of the insert made of electrically conductive material 15 no battery component 1 is axially overlapping.

The annular welding 42 does not comprise filler material but is a mutual melting between the connection portion 21 of the insert made of electrically conductive material 15, the upper portion 8 of the hollow container 2 and the peripheral portion 31 of the lid 30.

The annular welding 42 is substantially visible, when the battery 1 is assembled, and appears as a ring placed on the outer surface 53 of the upper portion 8 of the hollow container 2.

The annular welding 42 is placed radially outside the radial space between the free end 13 of the upper portion 8 of the hollow container 2 and the lid 30.

The annular welding 42 is placed radially outside the free end 29 of the connection portion 21 of the insert made of electrically conductive material 15.

The annular welding 42 has a thickness SP in the radial direction, understood as welding thickness (as illustrated in FIGS. 4 and 5), less than 1 millimetre, preferably less than 0.5 millimetres.

The thickness SP of the annular welding 42 is greater than 10 microns, preferably greater than 20 microns.

For example, the thickness SP of the annular welding 42 is between 20 microns and 600 microns, preferably between 20 microns and 300 microns, more preferably between 20 microns and 200 microns, for example between 20 microns and 100 microns.

In accordance with the embodiment illustrated in FIGS. 2 and 4, the outer surface 53 of the upper portion 8 of the hollow container 2 is substantially flat and the outer surface portion 53 on which the annular welding 42 is carried out is substantially coplanar with outer surface portions 53 not affected by the annular welding 42.

In accordance with the embodiment illustrated in FIGS. 3 and 5, the upper portion 8 of the hollow container 2 comprises an annular recess 54.

The annular recess 54 is placed radially outside the radial space between the free end 13 of the upper portion 8 of the hollow container 2 and the lid 30.

The annular recess 54 is placed radially outside the free end 29 of the connection portion 21 of the insert made of electrically conductive material 15.

The annular recess 54 comprises a bottom wall 55 delimited by two opposite side walls 56.

The annular welding 42 is placed within the annular recess 54 and on the bottom wall 55 of the annular recess 54.

The distance separating the two opposite side walls 56 of the annular recess in the radial direction defines an extension ER in the radial direction of the annular recess 54.

The extension in the axial direction of one of the two opposite side walls 56 of the annular recess 54 defines an extension EA in the axial direction of the annular recess 54.

The extension ER in the radial direction of the recess 54 is between 0.2 millimetres and 4 millimetres, preferably between 0.4 millimetres and 3 millimetres, more preferably between 0.5 millimetres and 2 millimetres, for example of about 1.5 millimetres.

The extension ER in the radial direction of the recess 54 is preferably 30 times greater than the thickness SP of the annular welding 42, more preferably 20 times greater than the thickness SP of the annular welding 42, more preferably 15 times greater than the thickness SP of the annular welding 42, for example about 10 times greater than the thickness SP of the annular welding 42.

The extension EA in the axial direction of the recess 54 is between 50 microns and 800 microns, preferably between 150 microns and 600 microns, more preferably between 200 microns and 500 microns, for example of about 400 microns.

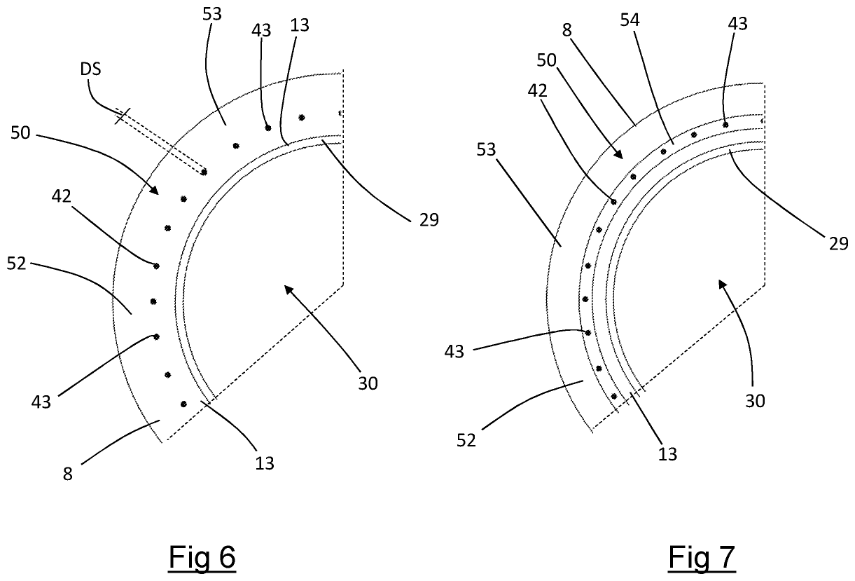

In accordance with the embodiment illustrated in FIGS. 6 and 7, the welding 42 is a spot welding 42 which, starting from the outer surface 53 of the upper portion 8 of the hollow container 2, reaches the peripheral portion 31 of the lid 30 crossing the connection portion 21 of the insert made of electrically conductive material 15.

The spot welding 42 comprises welding spots 43 arranged along a substantially circular path on the outer surface 53 of the upper portion 8 of the hollow container 2, as schematically illustrated in FIGS. 6 and 7 (which represent top views of a portion of the battery 1).

The welding spots 43 are preferably equidistant from each other along the circular path.

The number of welding spots 43 is between 4 and 60, preferably between 8 and 40.

In this embodiment, the free end 29 of the connection portion 21 of the insert made of electrically conductive material 15 is directly facing the external environment. At the free end 29 of the connection portion 21 of the insert made of electrically conductive material 15 no battery component 1 is axially overlapping.

The spot welding 42 does not comprise filler material but is a mutual melting between the connection portion 21 of the insert made of electrically conductive material 15, the upper portion 8 of the hollow container 2 and the peripheral portion 31 of the lid 30.

The welding spots 43 are substantially visible, when the battery 1 is assembled, and appear as spots aligned along a circumference and placed on the outer surface 53 of the upper portion 8 of the hollow container 2.

The spot welding 42 is placed radially outside the radial space between the free end 13 of the upper portion 8 of the hollow container 2 and the lid 30.

The spot welding 42 is placed radially outside the free end 29 of the connection portion 21 of the insert made of electrically conductive material 15.

Each welding spot 43 has a diameter DS (understood as the diameter of a circumference that best approximates a welding spot 43), between 20 microns and 400 microns, preferably between 20 microns and 300 microns, more preferably between 20 microns and 100 microns, for example of about 60 microns.

The diameters DS of all the welding spots 43 are substantially the same.

In accordance with the embodiment illustrated in FIG. 7, the outer surface 53 of the upper portion 8 of the hollow container 2 is substantially flat and the outer surface portion 53 on which the annular welding 42 is carried out is substantially coplanar with outer surface portions 53 not affected by the annular welding 42.

In accordance with the embodiment illustrated in FIG. 7, the upper portion 8 of the hollow container 2 comprises an annular recess 54.

The annular recess 54 is placed radially outside the radial space between the free end 13 of the upper portion 8 of the hollow container 2 and the lid 30.

The annular recess 54 is placed radially outside the free end 29 of the connection portion 21 of the insert made of electrically conductive material 15.

The annular recess 54 comprises a bottom wall 55 delimited by two opposite side walls 56.

The spot welding 42 is placed within the annular recess 54 and on the bottom wall 55 of the annular recess 54.

The distance separating the two opposite side walls 56 of the annular recess in the radial direction defines an extension ER in the radial direction of the annular recess 54.

The extension in the axial direction of one of the two opposite side walls 56 of the annular recess 54 defines an extension EA in the axial direction of the annular recess 54.

The extension ER in the radial direction of the recess 54 is between 0.2 millimetres and 4 millimetres, preferably between 0.4 millimetres and 3 millimetres, more preferably between 0.5 millimetres and 2 millimetres, for example of about 1.5 millimetres.

The extension ER in the radial direction of the recess 54 is preferably 30 times greater than the diameter DS of each welding spot 43, more preferably 20 times greater than the diameter DS of each welding spot 43, more preferably 15 times greater than the diameter DS of each welding spot 43, for example about 10 times greater than the diameter DS of each welding spot 43.

The extension EA in the axial direction of the recess 54 is between 50 microns and 800 microns, preferably between 150 microns and 600 microns, more preferably between 200 microns and 500 microns, for example of about 400 microns.

In accordance with the embodiment illustrated in FIGS. 8 and 9, the welding 42 is obtained at the free end 29 of the connection portion 21 of the insert made of electrically conductive material 15.

In this embodiment, the welding 42 fills at least partially the radial space between the free end 13 of the upper portion 8 of the hollow container 2 and the lid 30 (as schematically illustrated in FIG. 8).

In this embodiment, the welding melts the free end 29 of the connection portion 21 of the insert made of electrically conductive material 15 on the free end 13 of the upper portion 8 of the hollow container 2 and on the lid 30.

In this embodiment, the welding 42 is annular in shape, as schematically illustrated in FIG. 9.

To assemble the electric battery 1, it is envisaged providing the hollow container 2, the lid 30, the insert made of electrically conductive material 15 and the electrochemical cell 9 as separate elements.

Subsequently, it is envisaged mechanically and electrically connecting the insert made of electrically conductive material 15 to the anode of the electrochemical cell 9.

This operation is implemented by welding the anode to the contact portion 14 of the insert made of electrically conductive material 15. In particular, it is envisaged welding the anode surface 19 to all the fins 22 of the contact portion 20 of the insert made of electrically conductive material 15.

The assembly consisting of electrochemical cell 9 and insert made of electrically conductive material 15 is subsequently inserted into the inner cavity 7 of the hollow container 2 with the anode facing the upper portion 8 of the hollow container 2.

Subsequently, it is envisaged closing the inner cavity 7 of the hollow container 2 with the lid 30.

This operation is carried out by creating the overlapping region 50 in which the upper portion 8 of the hollow container 2 is positioned axially above the lid 30 and above the connection portion 21 of the insert made of electrically conductive material 15.

The closing of the inner cavity 7 of the hollow container 2 with the lid 30 can be implemented according to the following operations.

The connection portion 21 of the insert made of electrically conductive material 15 is placed in direct electrical contact and in direct physical contact on the upper portion 8 of the hollow container 2.

This operation is implemented by at least partially overlapping the connection portion 21 of the insert made of electrically conductive material 15 with the upper portion 8 of the hollow container 2.

As illustrated in FIG. 13, the connection portion 21 of the insert made of electrically conductive material 15 is placed on the upper portion 8 of the hollow container 2 with the curved section 27 of the connection portion 21 overlapping the curved section 11 of the upper portion 8 of the hollow container 2. The further straight section 28 of the connection portion 21 is placed against the further straight section 12 of the upper portion 8 of the hollow container 2. The straight section 26 of the connection portion 21 is placed on the straight section 10 of the upper portion 8 of the hollow container 2.

The connection portion 21 of the insert made of electrically conductive material 15 is completely contained radially within the upper portion 8 of the hollow container 2.

Subsequently, it is envisaged placing the peripheral portion 31 of the lid 30 in direct physical contact with the connection portion 21 of the insert made of electrically conductive material 15.

This operation envisages at least partially overlapping the peripheral portion 31 of the lid 30 with the connection portion 21 of the insert made of electrically conductive material 15.

As illustrated in FIG. 14, the peripheral portion 31 of the lid 30 is placed on the connection portion 21 of the insert made of electrically conductive material 15 with the straight section 32 of the peripheral portion overlapping the curved section 27 of the connection portion 21.

Subsequently, it is envisaged mechanically joining the connection portion 21 of the insert made of electrically conductive material 15, the upper portion 8 of the hollow container 2 and the peripheral portion 31 of the lid 30 and to put the peripheral portion 31 of the lid 30 in electrical contact with the upper portion 8 of the hollow container 2.

This operation is implemented by plastically cold deforming at least the connection portion 21 of the insert made of electrically conductive material 15 and the upper portion 8 of the hollow container 2.

As illustrated in FIG. 15, only the connection portion 21 of the insert made of electrically conductive material 15 and the upper portion 8 of the hollow container 2 are plastically deformed.

Such deformation provides for plastically deforming the connection portion 21 of the insert made of electrically conductive material 15 to form the curve 41. With the same plastic deformation operation, the upper portion 8 of the hollow container 2 is also plastically deformed to form the curve 40. Thus, the curve 41 of the connection portion 21 and the curve 40 of the upper portion 8 are formed simultaneously.

The plastic deformation of the connection portion 21 of the insert made of electrically conductive material 15 and of the upper portion 8 of the hollow container 2 permanently constrains the peripheral portion 31 of the lid 30 to the containment body 2 and puts the peripheral portion 31 of the lid 30 in direct and permanent electrical contact with the upper portion 8 of the hollow container 2 (as well as with the connection portion 21 of the insert made of electrically conductive material 15).

The plastic deformation of the connection portion 21 of the insert made of electrically conductive material 15 and of the upper portion 8 of the hollow container 2 is implemented by cold bending simultaneously the further straight section 12 of the upper portion 8 and the further straight section 28 of the connection portion 21 on the peripheral portion 31 of the lid 30. The plastic deformation of the connection portion 21 of the insert made of electrically conductive material 15 and of the upper portion 8 of the hollow container 2 places the free end 29 of the connection portion 21 radially between the lid 30 and the free end 13 of the upper portion 8.

When the inner cavity 7 of the hollow container 2 with the lid 30 has been made and the overlapping region 50 has been made, it is provided to weld together the connection portion 21 of the insert made of electrically conductive material 15, the upper portion 8 of the hollow container 2 and the lid 30 at the overlapping region 50.

This operation is performed by acting with a welder on the side facing the external surface 53 of the upper portion 8 of the hollow container 2.

In the embodiments of FIGS. 2 to 7, it is envisaged performing the welding 42 with a laser welder.

The laser welder emits a laser beam onto the outer surface 53 of the outer surface 53 of the upper portion 8 of the hollow container 2 which melts, crossing them and melting them together, the upper portion 8 of the hollow container 2, the connection portion 21 of the insert made of electrically conductive material 15 until it reaches the peripheral portion 31 of the lid 30.

The emitted laser beam does not cross the peripheral portion 31 of the lid 30.

The welding 42 does not cross the peripheral portion 31 of the lid 30 which continues to seal the cavity 7 in a fluid-tight manner.

The size of the spot of the laser welder reaching the outer surface 53 of the upper portion 8 of the hollow container 2 is substantially equal to the thickness SP in the radial direction of the welding 42 when it is envisaged to be annular.

The size of the spot of the laser welder reaching the outer surface 53 of the upper portion 8 of the hollow container 2 is substantially equal to the diameter DS of a welding spot 43 when a spot welding is envisaged.

To perform the welding 42 the laser welder emits a laser beam on the outer surface 53 of the upper portion 8 of the hollow container 2 with a fluence (energy per unit area) between 40 Joules/square centimetre and 4000 Joules/square centimetre, more preferably between 80 Joules/square centimetre and 3000 Joules/square centimetre, more preferably between 150 Joules/square centimetre and 2200 Joules/square centimetre, more preferably between 220 Joules/square centimetre and 850 Joules/square centimetre, for example between 400 Joules/square centimetre and 650 Joules/square centimetre.

The power of the laser welder is between 600 Watt and 2500 Watt, more preferably between 700 Watt and 2000 Watt, more preferably between 850 Watt and 1800 Watt, more preferably between 1000 Watt and 1600 Watt, for example of about 1300 Watt.

Preferably, the feed rate of the laser beam along the outer surface 53 of the upper portion 8 of the hollow container 2 during welding is between 100 millimetres per second and 1500 millimetres per second, more preferably between 150 millimetres per second and 1000 millimetres per second, more preferably between 200 millimetres per second and 700 millimetres per second, more preferably between 220 millimetres per second and 680 millimetres per second, for example of about 400 millimetres per second.

In the embodiments of FIGS. 2 to 5, the annular welding 42 is obtained by directing the beam emitted by the laser welder along a circular path on the outer surface 53 of the upper portion 8 of the hollow container 2.

This operation can be implemented by rotating the laser beam around the circular path and holding the battery 1 stationary, or by rotating the battery 1 and holding the laser beam stationary.

In these embodiments the laser beam is implemented without interruptions from the beginning of the welding process to the end.

In the embodiments of FIGS. 6 and 7, the spot welding 42 is obtained by directing the beam emitted by the laser welder along a circular path and at the spots at which the welding spots 43 are to be provided.

This operation can be implemented by rotating the laser beam around the circular path and holding the battery 1 stationary, or by rotating the battery 1 and holding the laser beam stationary.

In these embodiments the laser beam is implemented by pulses, i.e. with interruptions in emission, between a welding spot 43 and the next.

In the embodiment of FIGS. 8 and 9, the welding 42 is obtained by melting the free end 29 of the connection portion 21 of the insert made of electrically conductive material 15.

This operation can be performed with a traditional welder or a laser welder.

The free end 29 of the connection portion 21 of the insert made of electrically conductive material 15 is melted so as to at least partially fill the radial space between the free end 13 of the upper portion 8 of the hollow container 2 and the lid 30.

The electric battery 1 is thus completely assembled.

1. A method for assembling an electric battery comprising:
providing a hollow container having a side wall and a bottom wall defining an inner cavity;
providing an upper portion of the hollow container opposite to said bottom wall along an axial direction and comprising an outer surface;
providing an insert made of electrically conductive material comprising a connection portion;
providing a lid;
inserting an electrochemical cell into the inner cavity of said hollow container;
mechanically and electrically connecting the insert made of electrically conductive material to a pole of said electrochemical cell;
closing the inner cavity of the hollow container with the lid, creating an overlapping region in which the upper portion of the hollow container is positioned axially above the lid and the connection portion of the insert made of electrically conductive material, and
welding together at least the connection portion of the insert made of electrically conductive material and the upper portion of the hollow container at the overlapping region by acting with a welder on a side facing the outer surface of the upper portion of the hollow container.

2. The method according to claim 1, wherein welding together at least the connection portion of the insert made of electrically conductive material and the upper portion of the hollow container further comprises welding together the insert made of electrically conductive material and the lid.

3. The method according to claim 1, wherein in said overlapping region the connection portion of the insert made of electrically conductive material is axially interposed between, and in contact with, the upper portion of the hollow container and the lid.

4. The method according to claim 3, wherein the connection portion of the insert made of electrically conductive material, the upper portion of the hollow container and the lid are welded together simultaneously.

5. The method according to claim 1, wherein creating said overlapping region comprises arranging said upper portion of the hollow container in such a way that it does not axially overlap a free end of said connection portion of the insert made of electrically conductive material.

6. The method according to claim 1, wherein welding comprises performing an annular welding by crossing the outer surface of the upper portion of the hollow container until reaching at least the connection portion of the insert made of electrically conductive material.

7. The method according to claim 1, wherein welding comprises performing a spot welding by crossing the outer surface of the upper portion of the hollow container until reaching at least the connection portion of the insert made of electrically conductive material.

8. The method according to claim 5, wherein welding comprises melting said free end of the connection portion of the insert made of electrically conductive material.

9. The method according to claim 1, wherein welding comprises directing a beam emitted by a laser welder onto the outer surface of the upper portion of the hollow container.

10. The method according to claim 9, wherein a size of a spot of the laser welder is between 30 microns and 300 microns.

11. The method according to claim 1, wherein closing the inner cavity of the hollow container comprises mechanically joining the connection portion of the insert made of electrically conductive material, the upper portion of the hollow container and a peripheral portion of the lid.

12. The method according to claim 11, wherein mechanically joining the connection portion of the insert made of electrically conductive material, the upper portion of the hollow container and a peripheral portion of the lid comprises plastically deforming at least the connection portion of the insert made of electrically conductive material and the upper portion of the hollow container.

13. The method according to claim 1, wherein mechanically and electrically connecting the insert made of electrically conductive material to the pole of said electrochemical cell is performed prior to inserting the electrochemical cell into the inner cavity of said hollow container.

14. The method according to claim 1, wherein mechanically and electrically connecting the insert made of electrically conductive material to the pole of said electrochemical cell comprises mechanically and electrically connecting the insert made of electrically conductive material to an anode of said electrochemical cell.
